(19) United States
(12) Patent Application Publication
(10) Pub. No.: US 2023/0376729 A1
(43) Pub. Date: Nov. 23, 2023

(54) METHOD FOR TRAINING A NEURAL NETWORK

(71) Applicant: Garena Online Private Limited, Singapore (SG)

(72) Inventors: YiChen ZHOU, Singapore (SG); Pan ZHOU, Singapore (SG); Shuicheng YAN, Singapore (SG)

(21) Appl. No.: 18/319,167

(22) Filed: May 17, 2023

(30) Foreign Application Priority Data
May 19, 2022 (SG) 10202205307X
Jul. 1, 2022 (SG) 10202250349U

(51) Int. Cl. G06N 3/0455; G06N 3/0985

(52) U.S. Cl. CPC G06N 3/0455; G06N 3/0985

(57) ABSTRACT

Aspects concern a method for training a neural network, comprising forming an autoencoder comprising the neural network as encoder and comprising a decoder, for each training image of multiple training images, generating a latent representation of the training image by the encoder, transforming the training image and supplying information about the transformation and at least a part of the latent representation to the decoder to generate a decoder output for the training image and adjusting the encoder and the decoder to reduce a loss between the transformed training images and the decoder outputs.

### CROSS REFERENCE TO RELATED APPLICATIONS

This patent application claims the benefit and priority of Singaporean Patent Application No. 10202250349U filed with the Intellectual Property Office of Singapore on Jul. 1, 2022 and claims the benefit and priority of Singaporean Patent Application No. 10202205307X filed with the Intellectual Property Office of Singapore on May 19, 2022, the disclosures of which are incorporated by reference herein in their entireties as part of the present application.

### TECHNICAL FIELD

Various aspects of this disclosure relate to methods for training a neural network.

### BACKGROUND

Self-supervised learning (SSL) aims to train a highly transferable deep model (i.e. a neural network) on unlabeled data by solving a well-designed pretext task which can generate pseudo targets for the task itself.

Autoencoders may be used to learn efficient encoding of data in a self-supervised manner. One option for efficiently training an encoder for a computer vision (downstream) task, e.g. a classification, object detection or segmentation task, is the masked autoencoder (MAE) approach.

For a pre-training phase, according to MAE, an input image where patches are randomly masked is fed into the encoder and the autoencoder is trained such that its decoder can reconstruct the pixels or features of the masked patches from the latent representation generated by the encoder and mask tokens (i.e. information about which patches are masked). After pre-training, the encoder is fine-tuned for the downstream task via standard supervised training.

One can observe that the core of the MAE framework is the masking on the encoder input, which unfortunately causes inconsistency between the pre-training and fine-tuning phases. Specifically, for the encoder, the input is a masked or incomplete one in the pre-training phase, while it is complete without masking in the fine-tuning phase. This inconsistency may impair the performance. Moreover, though being well compatible with the vision transformers (ViT) encoder, the masking strategy employed on the encoder input according to MAE prohibits the pre-training of other popular and effective encoder architectures, e.g. CNN (convolutional neural network), MLP(multi-layer perceptron)-based architectures, or others. This is because these popular architectures cannot handle incomplete input due to convolutions and pooling operations in CNNs and fully-connected layers in MLP-based architectures.

Accordingly, approaches for training a neural network are desirable which achieve good results without masking of the encoder input.

### SUMMARY

Various embodiments concern a method for training a neural network, including forming an autoencoder including the neural network as encoder and including a decoder, for each training image of multiple training images, generating a latent representation of the training image by the encoder, transforming the training image and supplying information about the transformation and at least a part of the latent representation to the decoder to generate a decoder output for the training image and adjusting the encoder and the decoder to reduce a loss between the transformed training images and the decoder outputs.

According to one embodiment, the method includes masking the latent representation and supplying the masked latent representation to the decoder to generate the decoder output.

According to one embodiment, the method includes subdividing the training image into a plurality of training image patches, wherein the latent representation includes an encoding for each training image patch and wherein masking the latent representation includes replacing at least some of the training image patches by mask tokens.

The image may be subdivided into the patches according to a regular pattern. In particular, the patches may all be of the same size. For example, an input image of size 224×224 pixels is divided into 14×14 patches of size 16×16 pixels.

According to one embodiment, the method includes randomly selecting the training image patches replaced by mask tokens.

According to one embodiment, the method includes adjusting the mask tokens and the encoder and the decoder to reduce the loss between the transformed training images and the decoder outputs.

According to one embodiment, the loss between the transformed training images and the decoder outputs includes a mean-square-error loss, a cosine distance or a Kullback-Leibler divergence of the transformed training images and the decoder outputs.

According to one embodiment, the transformation includes a feature extraction of the training image followed by a homography transformation.

According to one embodiment, the transformation is a homography transformation of the training image.

According to one embodiment, the information about the transformation is an encoding of hyper parameters of the transformation.

According to one embodiment, the method includes generating the encoding of hyper parameters of the transformation by a further neural network.

According to one embodiment, the method includes adjusting the further neural network and the encoder and the decoder to reduce the loss between the transformed training images and the decoder outputs.

According to one embodiment, the neural network is a convolutional neural network a vision transformer network or a multi-layer perceptron-based neural network. Other types of neural networks for computer vision may also be used, i.e. the method is flexible with regard to the structure of the encoder.

According to one embodiment, a training device is provided configured to perform the method for training a neural network as described above.

According to one embodiment, a computer program element is provided including program instructions, which, when executed by one or more processors, cause the one or more processors to perform the method for training a neural network as described above.

According to one embodiment, a computer-readable medium is provided including program instructions, which, when executed by one or more processors, cause the one or more processors to perform the method for training a neural network as described above.

It should be noted that embodiments described in context of the method are analogously valid for the device.

### BRIEF DESCRIPTION OF THE DRAWINGS

The invention will be better understood with reference to the detailed description when considered in conjunction with the non-limiting examples and the accompanying drawings, in which:

FIG. 1 shows an autoencoder.

FIG. 2 illustrates a masked autoencoder approach for training a neural network.

FIG. 3 illustrates the TAE (Transformed Autoencoder) approach for training a neural network.

FIG. 4 illustrates the partitioning of an encoder input into non-overlapping patches to tokenize them into a series of patch tokens which are then fed into a decoder to obtain a series of pixels for predicting a spatially transformed target.

FIG. 5 shows a flow diagram illustrating a method for training a neural network.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of a device are analogously valid for a method and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

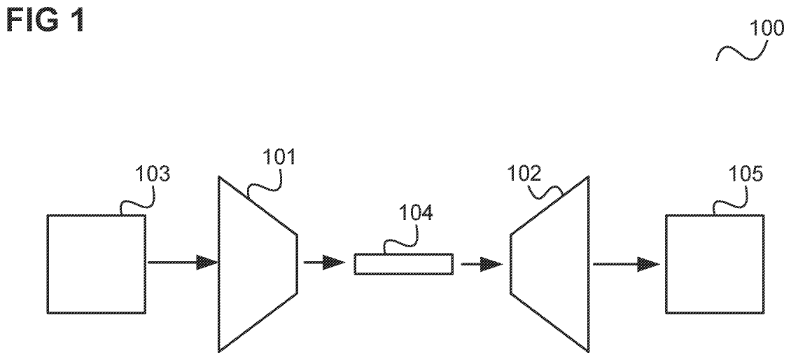

FIG. 1 shows an autoencoder 100.

The autoencoder 100 includes an encoder 101 and a decoder 102 (both implemented by a respective neural network).

The encoder 101 encodes an input 103 to a latent representation 104 in a latent space and the decoder 102 generates an output from a latent representation.

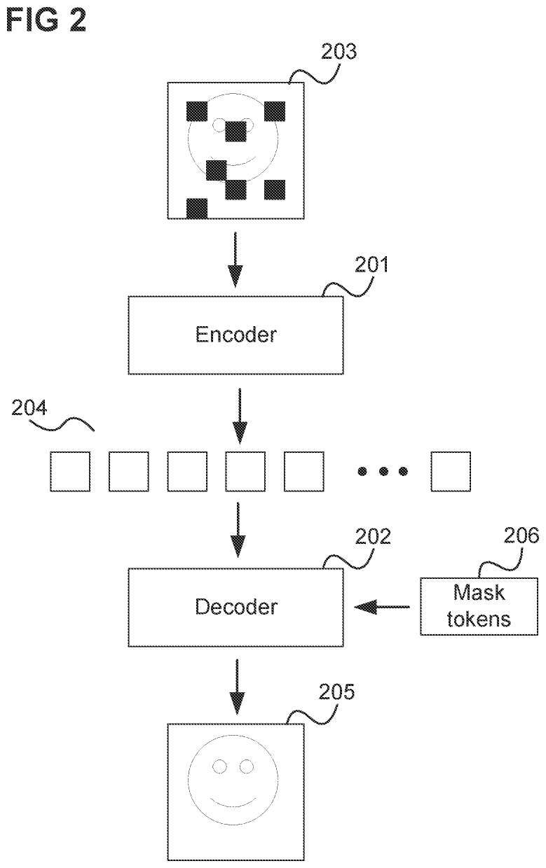

According to the MAE (Masked Autoencoder) approach (more generally a masked image modelling SSL approach), the input 103, which is in that case an image, is masked before it is fed into the encoder 101, as illustrated in FIG. 2.

FIG. 2 illustrates a masked autoencoder approach.

In this approach, the encoder 201 receives as input 203 an image in which patches are randomly masked, i.e. the encoder 201 receives as input 203 only the patches of the image which are not masked. The encoder 201 encodes each unmasked patch to a respective encoded patch. The encoded patches form together the latent representation 204. The decoder 202 is to generate an output 205 by reconstructing the pixel values of the masked patches from the latent representation of the encoder and mask tokens 206 (which take the place of encodings for patches which have been masked). This mask reconstruction pretext task (for pre-training of the neural network taking the place of the encoder 201) is also denoted as masked image modelling. Given a specific downstream task, this SSL family fine-tunes the pre-trained encoder on the corresponding training data in a supervised manner.

However, the fact that for the encoder the input is masked for pre-training and is not masked for fine-tuning causes inconsistency in training and may impair performance. Further, encoder architectures like CNNs and MLP-based architectures are not compatible with the masking strategy on the encoder input, which limits wider application of the MAE-like SSL family.

In view of the above, according to various embodiments, a training approach is provided which is mask-free at the encoder input and thus avoids the above two issues. The approach provided, which is denoted as TAE (Transformed Autoencoder) approach, uses transformed image modelling to reconstruct the input image or its semantic feature.

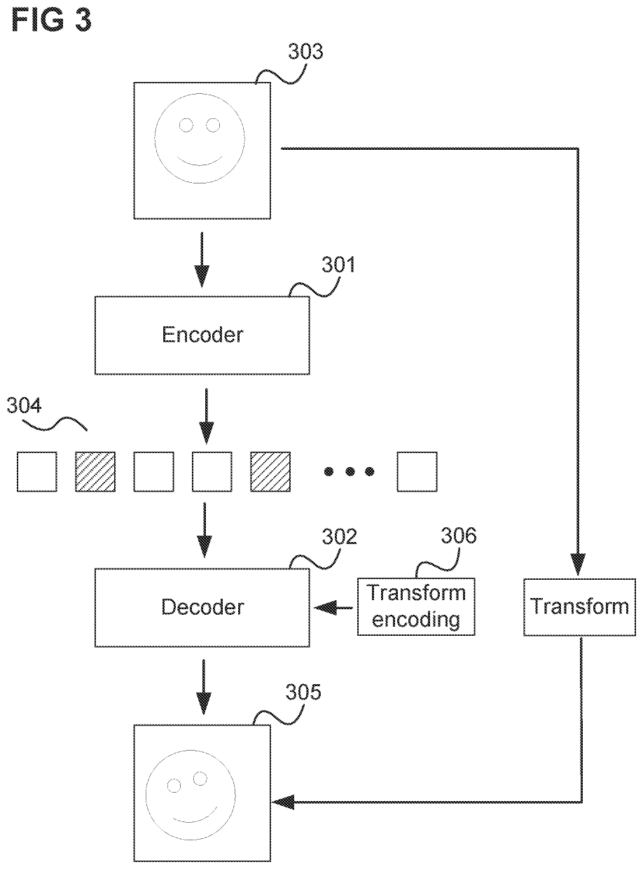

FIG. 3 illustrates the TAE approach for mask-free encoder (i.e. without mask at the encoder's input) pre-training.

According to the TAE approach, an encoder 301, denoted as f for the encoding function it implements, is used to encode a (full, i.e. unmasked) input image 203 (which may be a crop of a larger image), denoted as x in the following, into a set of latent patch tokens, i.e. a latent representation 304, denoted as z, including an encoding (encoding token, also referred to as latent patch token) for each of a plurality of patches into which the input image 203 is subdivided. The encoder 301 is trained together with the decoder 302 such that the decoder 302, denoted as g, recovers a spatially transformed version [symbol] (x) of the input x from the latent representation 304 in which encoding tokens are randomly masked (i.e. replaced by mask tokens, i.e. there are mask tokens at the masked positions within the latent representation) and an embedding 306 of parameters of the spatial transformation [symbol] . The reconstruction target can, instead of the transformed version of the input image [symbol] (x) also be semantic features [symbol] (f′(x)) of the input image, where f′ is, for example, the exponentially moving average off.

In the following, a Vision Transformer (ViT) is used as an example as the encoder 301 but other architectures, such as CNN and MLP-based networks, can also be implemented as the encoder 301 in TAE. Accordingly, in the following, it is described how a ViT backbone network can be trained as an encoder within a TAE framework.

As mentioned above, the input image 303 is divided into a set of non-overlapping patches and these patches are fed into the encoder 301. The encoder 301, in this example a standard ViT network, uses a linear projection to generated latent space embeddings (or encodings) for the image patches, and then adopts a series of transformer blocks to process the patch embeddings with positional embeddings added at the beginning. In this way, the encoder 301 outputs a series of latent patch tokens, which form the latent representation 304.

The decoder 302 consists of a series of standard transformer blocks. In the following, it is described how the decoder 302 processes the latent patch tokens z given by the encoder 301.

A spatial image transformation [symbol] is selected from a set of possible transformations and values of hyper-parameters σ which specify the selected transformation among the possible transformations are encoded into the transformation embedding (or encoding) 306, denoted as [symbol] via a small, e.g. 2-layer, MLP according to

[symbol]

=MLP(σ)ϵ [symbol] ^{d}, (1)

where d denotes the dimension of the latent patch tokens z. For example, to implement the spatial transformation [symbol] a homography transformation with eight degrees of freedom is used (the most general type of spatial transformations on 2D planes).

Then, the latent patch tokens z are randomly masked by replacing each one of (randomly) selected tokens with a shared and learned (i.e. trainable) mask token (as represented by the hatched tokens of the latent representation 304). Next, positional embeddings are added to all tokens in z to tell the locations of all patches (to which the tokens correspond) in the (original) image x. Finally, the hyper-parameter embedding [symbol] of [symbol] is concatenated to each token (mask token or token generated by the encoder 301) so as to include into each token the information on what spatial transformation has been performed. Alternatively, [symbol] may be directly added to each token.

The result of this processing of the latent patch tokens z is fed to the decoder 302 to obtain a prediction 305, denotes as [symbol] ′.

Regarding the reconstruction target [symbol] for [symbol] ′, there are for example the options to
i) recover the spatially transformed pixels y of the image x and
ii) reconstruct a spatially transformed semantic feature y of the image x, i.e. y is given by

$$y = \{ \begin{matrix}{𝒯}_{s} ( x ) , \\ {𝒯}_{s} ( {f}^{′} ( x ) ) ,\end{matrix} \qquad ( 2 )$$

wherein the upper option corresponds to the target being pixel reconstruction and the lower option corresponds to the target being feature reconstruction.

Here, f′ is the exponentially moving average of f.

With the target [symbol] as for example above, the training loss of TAE may be defined as follows:

$${min}_{f , g} \frac{1}{\vert 𝒦 \vert} ℓ ( {y}_{i} , {y}_{i}^{′} ) , \qquad ( 3 )$$

where [symbol] ᵢ denotes the component for the i-th patch in [symbol] , [symbol] denotes a set of consisting of the position indexes of patches of the input image x.

Here the loss function l measures the discrepancy between the prediction [symbol] ′ᵢ and the ground truth [symbol] ᵢ, e.g. the mean-square-error (MSE), cosine distance or KL Divergence.

The encoder 301 and the decoder 303 may be pre-trained on a large-scale unlabeled dataset (e.g. for 300 epochs on RGB images), and then take the encoder 301 as a feature extractor with or without fine-tuning (e.g. for 200 epochs) on other labelled datasets (e.g. on RGB images). The training data may include images of ImageNet-1k.

The spatial transformation [symbol] on the reconstruction target can be seen as a key component in TAE. It helps the encoder 301 to better learn the dependency among different patches in an image and also enhances data semantics learning.

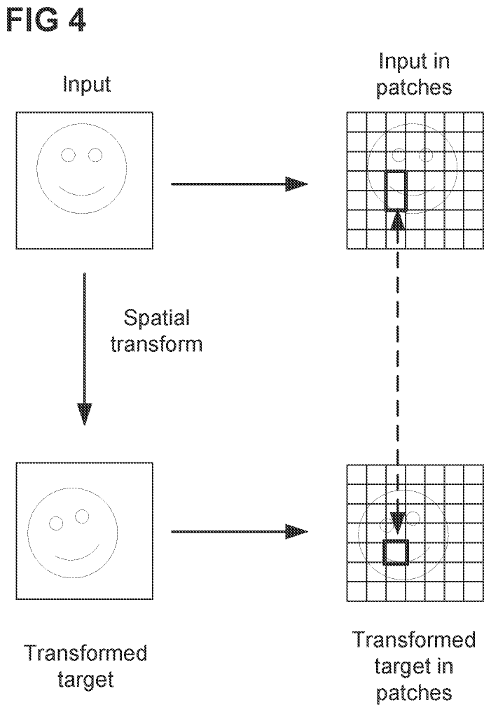

FIG. 4 illustrates the partitioning of the encoder input into non-overlapping patches to tokenize them into a series of patch tokens z, which are then fed into the decoder 302 to obtain a series of pixels [symbol] ᵢ for predicting a spatially transformed target [symbol] (x). Since the encoder input x differs from the target [symbol] (x) due to the spatial transformation [symbol] , the spatial partition for the patch tokens z in the encoder 301 and decoder 302 is different from the one in the target [symbol] (x). This means that there is no exact one-to-one correspondence between the patches based on which the encoder 301 generates the patch tokens z and those of the target [symbol] (x). Actually, as shown by the bold rectangle in the bottom right and the larger bold rectangle in the top right of FIG. 3, a patch in the transformed target can correspond (i.e. include information of) multiple patches in the input and, vice versa, the content of one token in z can be separated into (i.e. relate to) several nearby patches in [symbol] (x) However, to predict the corresponding patches in [symbol] (x), the patches of the decoder prediction [symbol] ′ have a one-to-one correspondence with the patches in [symbol] (x). The prediction content of one token in [symbol] thus actually comes from several nearby patch tokens in z. Therefore, by the training, the TAE encoder 301 and the TAE decoder 302 are trained to exchange sufficient information among tokens for fusing several nearby token patches together to achieve small reconstruction loss. This accordingly induces patch dependency learning and also enhances learning of data semantics. Moreover, due to the masks on the decoder input, some of the necessary nearby tokens may be masked. This further boosts the encoder to exchange sufficient information among tokens such that each unmasked token in the decoder has contained enough information of other tokens and the decoder can use them to well predict the masked patches.

The random masking applied to the input of the decoder 302 further enhances the representation power of the features (i.e. encodings) learned in training, in addition to training the machine-learning model (i.e. the autoencoder) to be aware of spatial transformations. While in the approach illustrated in FIG. 2 image patches (e.g. of a Vision Transformer) is masked at the input of the encoder on x the model is to recover the masked regions, masking is performed after the encoder according to TAE on the latent representation z, i.e. there is a masking operation zₘ=mask(z) wherein a certain number of patch encodings is masked. For example, for 50% of the patches the encodings are masked (e.g. around 98 encodings are masked). By reconstructing all patches at the output of the decoder 302 from the masked latent representation zₘ, each (local, i.e. patch) encoding in zₘ is trained to have a better representation of the whole input image 303. Unlike the spatial transformation that changes both the reconstruction target and the latent representation, the masking only changes the latent representation z and does not affect the reconstruction target.

As aforementioned, TAE does not mask the encoder input, and thus can be easily used to train other types of popular and effective architectures, including CNNs (e.g. ResNet [48]) and MLP-based networks (e.g. MLP-Mixers), etc. In principle, to pre-train such a non-ViT backbone with TAE, one can directly use the non-ViT backbone to implement the TAE encoder. But for a CNN and MLP-based backbone, one needs to remove its global pooling and fully connected layers at the end of the respective neural network (if there are any). Besides, for a CNN, e.g. ResNet, its output feature map is often of spatial-size 7×7 which is much smaller than the input size 224×224. To make the output feature map preserve more spatial details of the input image, a transposed convolution may be applied to the last stage, which may then be summed with the feature map from the second last stage to form a feature map of size 14×14. For a MLP-Mixer, its latent patch tokens are the output of the last block like ViT without any special operation. For a TAE decoder, standard transformer blocks may be used to implement it for simplicity and consistency.

The decoder may be discarded after pre-training (i.e. before the fine-tuning phase).

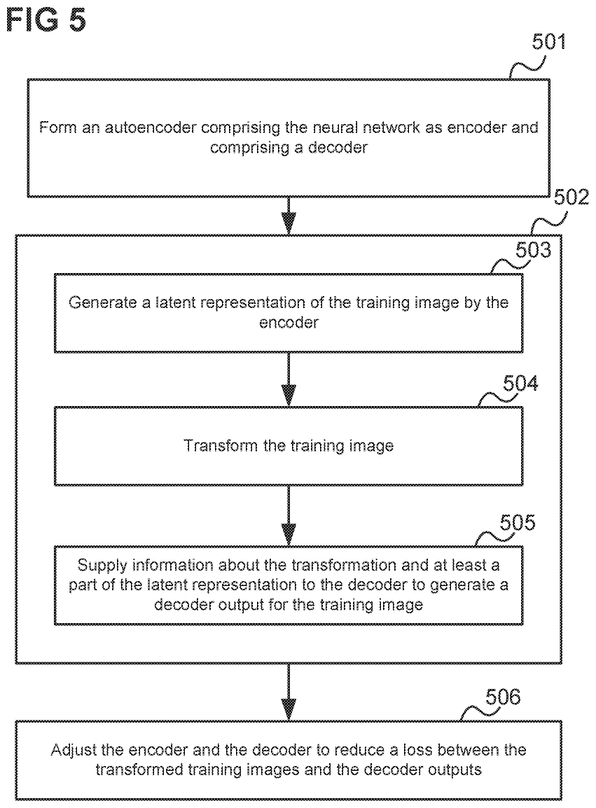

In summary, according to various embodiments, a method is provided as illustrated in FIG. 5.

FIG. 5 shows a flow diagram 500 illustrating a method for training a neural network.

In 501 an autoencoder is formed including the neural network as encoder and including a decoder.

In 502, for each training image of multiple training images
a latent representation of the training image is generated by the encoder in 503 (by applying it to, according to various embodiments, the unmasked training image);
the training image is transformed in 504; and
information about the transformation and at least a part of the latent representation are supplied to the decoder to generate a decoder output for the training image in 505.

In 506 the encoder and the decoder are adjusted to reduce a loss between the transformed training images and the decoder outputs.

The encoder for example determines the latent representation by determining patch-wise encodings of the training image (and, in inference, of the respective input image) of a subdivision of the training image into a plurality of patches. The transformation may for example be understood as a transformation which changes the association of pixels with patches, i.e. for each of at least some (not necessary all but a major part, e.g. 20%, 30% or 40%) of the pixels the pixel value of the pixel is shifted to another patch by the transformation.

The transformation is different for at least some of the training images, i.e., for example, parameters of the transformation differ between (at least some of) the training images.

For example, as mentioned above, each training picture may be crop of a larger, original image. According to various embodiments, each transformation is a transformation on the original image such that the transformed crop (i.e. part of the image) takes contents from a region completely within the original image. More specifically, for example, a base crop is defined by the coordinates of its 4 vertices in the original image p₀=(xmin, ymin), p₁=(xmax, ymin), p₂=(xmax, ymax), p₃=(xmin, ymax). The scale of the crop is denoted as the length of its shorter side sₓ=min(xmax−xmin, ymax−ymin). Then for each vertex pᵢ, a new point pᵢ^{t} is randomly chosen within a small squared region of size λsₓ centred around pᵢ. For example, by default, λ=0. The corresponding region with the transformed vertices p₀^{t}, p₁^{t}, p₂^{t}, p₃^{t} is then extracted from the original image, followed by resizing it to the training size image (e.g. 224×224 pixels) to form the transformed crop. The transformation parameters for this transformation are then obtained by calculating the perspective transformation matrix between the original coordinates p₀, p₁, p₂, p₃ to the new coordinates p₀^{t}, p₁^{t}, p₂^{t}, p₃^{t}. According to one embodiment, during pre-training, the probability of applying the spatial transform is linearly increased from 0 to 0.5. For image crops without the spatial transform, the same original crop is used as the reconstruction target.

The approach of FIG. 5, e.g. in form of the TAE approach detailed above, allows building an unsupervised pre-training framework applicable to general network architectures.

It thus achieves architecture compatibility and further allows achieving training consistency and orthogonality to other self-supervised learning (SSL) methods.

Firstly, with the mask-free (at the encoder input) encoder pre-training mechanism according to TAE, for both pre-training and fine-tuning phases, the full input image is fed into the encoder. In this way, for both phases, the TAE encoder always sees the whole picture of the input, and thus can consistently handle and learn the input patches. In contrast, for the MAE-like framework (illustrated in FIG. 2), the encoder input is masked in the pre-training phase but not masked in the fine-tuning phase, which indicates encoder training inconsistency between the two phases.

As mentioned above, the TAE encoder can be compatible to many popular and effective network architectures, including not only ViTs but also CNNs and MLP-based networks. This compatibility comes in particular from the mask-free strategy on the TAE encoder. In contrast, the MAE-like framework is often not suitable for non-ViT architectures and suffers from an architecture compatibility issue. This is because it cannot handle masked input due to convolutions and pooling operations in architectures like CNNs or spatial-MLP layers in MLP-based architectures.

Further, TAE with transformed image reconstruction is a very general framework and is compatible to many SSL families, such as MAE-like frameworks and contrastive learning methods. It can be combined with other SSL approaches to enjoy merits of both sides. Experimental results show that integrating the transformed image reconstruction task in TAE with the MAE-like framework, e.g. MAE, can improve their performance.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for training a neural network, comprising:
forming an autoencoder comprising a neural network as an encoder and a decoder;
for each training image of multiple training images, generating a latent representation of the training image by the encoder;
transforming each training image to produce transformed training images;
supplying information about the transformation and at least a part of the latent representation to the decoder to generate a decoder output for the training image; and
adjusting the encoder and the decoder to reduce a loss between the transformed training images and the decoder outputs.

2. The method of claim 1, further comprising:
masking the latent representation and supplying the masked latent representation to the decoder to generate the decoder output.

3. The method of claim 2, further comprising:
subdividing each training image into a plurality of training image patches, wherein the latent representation comprises an encoding for each training image patch, wherein masking the latent representation further comprising replacing at least one of the plurality of training image patches by mask tokens.

4. The method of claim 3, further comprising randomly selecting the mask tokens.

5. The method of claim 4, further comprising adjusting the mask tokens, the encoder, and the decoder to reduce the loss between the transformed training images and the decoder outputs.

6. The method of claim 1, wherein the loss between the transformed training images and the decoder outputs further comprises a mean-square-error loss, a cosine distance, or a Kullback-Leibler divergence of the transformed training images and the decoder outputs.

7. The method of claim 1, wherein the transformation comprises a feature extraction of the training image followed by a homography transformation.

8. The method of claim 1, wherein the transformation is a homography transformation of the training image.

9. The method of claim 1, wherein the information about the transformation is an encoding of hyper parameters of the transformation.

10. The method of claim 9, further comprising generating the encoding of hyper parameters of the transformation by a further neural network.

11. The method of claim 10, further comprising adjusting the further neural network, the encoder, and the decoder to reduce the loss between the transformed training images and the decoder outputs.

12. The method of claim 11, wherein the neural network is a convolutional neural network, a vision transformer network, or a multi-layer perceptron-based neural network.

13. A system comprising one or more computers and one or more storage devices storing computer-readable instructions that, when executed by the one or more computers, cause the one or more computers to perform one or more operations comprising:
forming an autoencoder comprising a neural network as an encoder and a decoder;
for each training image of multiple training images, generating a latent representation of the training image by the encoder;
transforming each training image to produce transformed training images;
supplying information about the transformation and at least a part of the latent representation to the decoder to generate a decoder output for the training image; and
adjusting the encoder and the decoder to reduce a loss between the transformed training images and the decoder outputs.

14. The system of claim 13, further comprising:
masking the latent representation and supplying the masked latent representation to the decoder to generate the decoder output.

15. The system of claim 14, further comprising:
subdividing each training image into a plurality of training image patches, wherein the latent representation comprises an encoding for each training image patch, wherein masking the latent representation further comprising replacing at least one of the plurality of training image patches by mask tokens.

16. The system of claim 15, further comprising randomly selecting the mask tokens.

17. The system of claim 16, further comprising adjusting the mask tokens, the encoder, and the decoder to reduce the loss between the transformed training images and the decoder outputs.

18. A non-transitory computer-readable media storing instructions that, when executed by one or more computers, cause the one or more computers to perform operations comprising:
forming an autoencoder comprising a neural network as an encoder and a decoder;
for each training image of multiple training images, generating a latent representation of the training image by the encoder;
transforming the each training image to produce transformed training images;
supplying information about the transformation and at least a part of the latent representation to the decoder to generate a decoder output for the training image; and
adjusting the encoder and the decoder to reduce a loss between the transformed training images and the decoder outputs.

19. The non-transitory computer-readable media of claim 18, wherein the transformation comprises a feature extraction of the training image followed by a homography transformation.

20. The non-transitory computer-readable media of claim 18, wherein the transformation is a homography transformation of the training image.
